(19) United States
(12) Patent Application Publication
(10) Pub. No.: US 2019/0131650 A1
(43) Pub. Date: May 2, 2019

(54) Flow-Based Cathode with Immobilized Non-Platinum Transition Metal Redox Catalyst

(71) Applicant: Wisconsin Alumni Research Foundation, Madison, WI (US)

(72) Inventors: Shannon S. Stahl, Madison, WI (US); Sourav Biswas, Madison, WI (US); Colin W. Anson, McFarland, WI (US); Yuliya Preger, Albuquerque, NM (US); Thatcher Root, Madison, WI (US)

(21) Appl. No.: 16/170,231

(22) Filed: Oct. 25, 2018

Related U.S. Application Data
(60) Provisional application No. 62/579,215, filed on Oct. 31, 2017.

(51) Int. Cl. H01M 8/18; H01M 4/90

(52) U.S. Cl. CPC H01M 8/188; H01M 2004/8689; H01M 4/9083

(57) ABSTRACT

Cathodic half-cells for the electrocatalytic reduction of oxygen are disclosed. Within the half-cell, a redox catalyst containing one or more non-Pt transition metals attached to a solid support (i.e., a “heterogenized” non-Pt transition metal-containing catalyst) is separate from and not in direct contact with the cathode electrode. In use, both the cathode electrode and the redox catalyst are in contact with an electrolyte solution that also contains a redox mediator. The oxidized form of the redox mediator is reduced at the cathode electrode, and the resulting reduced form migrates to the redox catalyst, where the mediator is oxidized back to its oxidized form, while oxygen is simultaneously reduced. The oxidized form of the redox mediator then migrates back to the cathode electrode, where the process is repeated. The disclosed cathodic half-cells can be used in combination with an anode half-cell in a variety of different electrochemical cells, such as in fuel cells or in electrosynthetic cells.

### CROSS-REFERENCE TO RELATED APPLICATIONS

This application claims the benefit of U.S. provisional Application No. 62/579,215 filed on Oct. 31, 2017, which is incorporated by reference herein in its entirety.

### STATEMENT REGARDING FEDERALLY SPONSORED RESEARCH/DEVELOPMENT

This invention was made with government support under DE-AC05-76RL01830 awarded by the US Department of Energy. The government has certain rights in the invention.

### BACKGROUND OF THE INVENTION

### 1. Field

The present disclosure relates to the cathode reaction (oxygen reduction) in proton exchange membrane (PEM) fuel cells or other electrochemical cells. More particularly, we disclose the use of a specific class of redox catalysts (redox catalysts containing one or more non-Pt transition metals affixed to a solid support) in flow-based cathodes, where the redox catalyst is not in direct contact with the cathode electrode.

### 2. Background

An electrochemical cell is a device comprising two half-cells, each of which comprises an electrode and an electrolyte. In operation, chemical species in one half-cell lose electrons (oxidation) to the electrode (the anode), while chemical species in the other half-cell gain electrons (reduction) from the electrode (the cathode). Each electrode is attached to a structure suitable for transmitting electricity through an external circuit. Furthermore, in order to maintain a compensatory flow of charge within the cell, certain ions may be allowed to move freely between the two half-cells (i.e., the two half-cells are in at least partial “ionic communication” with each other).

In one type of electrochemical cell, electrical energy is generated by the spontaneous reaction occurring at each half-cell (together, a redox reaction). Such cells are sometimes called voltaic or galvanic cells. In another type of electrochemical cell, known as an electrosynthetic cell, a desired chemical product is synthesized at the anode or cathode. Such cells may, like voltaic cells, generate electricity as a byproduct of the desired synthesis, or alternatively, they may require that electrical current is continuously applied to drive a non-spontaneous redox reaction. As an example of an electrosynthetic cell, an alcohol may be oxidized at the anode, and oxygen or another oxidizing agent may be reduced at the cathode. Note that in operation, the same oxygen reduction reaction may occur at the cathode in either a fuel cell or an electrosynthetic cell.

Fuel cells, which are a specific type of galvanic cell, are comprised of two half cells, with an electrolyte separating them that allows for ions to flow. At the anode, a fuel or reductant (with typical examples of fuels including but not limited to: hydrogen, methane, methanol, or biomass) is oxidized and at the cathode, oxygen or another oxidizing agent is reduced. Electrons flow from the anode to the cathode through an external circuit, and ions flow between the anode and cathode to maintain charge balance between the respective half-cells. The electricity generated from the flow of electrons can be used in a variety of applications, such as for generating primary or backup electrical power in stationary or mobile applications and supplying the electricity needed to power an electric vehicle, such as a forklift or an automobile.

Platinum cathodes are widely used to facilitate oxygen reduction in PEM fuel cells. Although these cathodes are considered state of the art, they are very expensive, due to platinum's relative scarcity. The difficult oxygen reduction reaction (ORR) requires prohibitively high amounts of platinum catalyst on the electrode. First-row transition metal (TM) catalysts have attracted significant attention in conventional fuel cells as alternatives to platinum, but have not reached commercial viability due to their insufficient catalytic ORR activity and poor stability under the fuel cell operating conditions.

An alternate strategy that addresses these concerns is moving the ORR away from the cathode electrode. Electrons are conducted from the cathode electrode to O₂ via soluble redox mediators, which are oxidized (as O₂ is reduced) at a heterogeneous redox catalyst that is not in contact with the electrode. This approach allows the ORR to be optimized separate from the chemistry associated with the electrode and membrane, while in conventional fuel cells these two processes are intimately connected. By having the redox catalyst and the oxygen reduction removed from the electrode, several advantages are realized. These include: use of non-conductive supports for the catalyst, higher loadings of less active catalysts, decreased plant complexity, and an increase in device modularity.

The general strategy of moving the O₂ reduction off of the cathode electrode by using redox mediators and redox catalysts (or combined redox catalyst/mediators) has been previously disclosed.

For example, polyoxometalates have been reported as combined redox catalysts and mediators for the cathode of fuel cells. U.S. Pat. No. 4,396,687 to Kummer et al. discloses a flow cathode containing H₅PMo₁₀V₂O₄₀ as a redox catalyst and VOSO₄ as a redox mediator. The anode of this fuel cell also contained a silicon-based polyoxometalate as a mediator and a heterogeneous Pt-based redox catalyst.

U.S. Pat. No. 9,005,828 to Creeth et al. discloses the use of polyoxometalates incorporating sodium ions and vanadium ions, such as Na₄H₃PMo₈V₄O₄₀, in a fuel cell with a conventional anode using H₂ as the fuel. U.S. Pat. No. 9,362,584 to Knuckey et al. reports that the addition of VOSO₄ mediators further improves the performance of a polyoxometalate redox catalyst.

A fuel cell utilizing polyoxometalates as redox mediators in both the anode and the cathode is disclosed in U.S. Patent Application No. 2016/0,344,055 to Deng et al. Biomass is used as the fuel, and the cathodic mediator in some instances is H₁₂P₃Mo₁₈V₇O₈₅.

Other redox mediators for use in the cathode of fuel cells have also been disclosed. For example, U.S. Pat. No. 3,152,013 to Juda discloses the use of a bromine/bromide redox couple as the redox mediator and NO_{N}-based species as redox catalyst for O₂ reduction in the cathode of a fuel cell.

U.S. Pat. No. 3,279,949 to Schaefer et al. discloses the use of vanadium salts as redox mediators in HCl or a mixed H₂SO₄/HBr/HNO₃ electrolyte in the cathode of a fuel cell.

U.S. Pat. No. 5,660,940 to Larsson et al. discloses a redox fuel cell using vanadium salts as the redox mediator in the cathode, with redox catalysts for O₂ reduction consisting of nitric oxide or a cobalt phthalocyanine.

U.S. Pat. No. 8,492,048 to Knuckey et al. discloses the use of a molecular iron-based redox catalyst and a ferrocene-based redox mediator in the cathode of a fuel cell. A conventional anode was used with H₂ fuel. Further work with nitrogen-complexed iron catalyst/mediators was disclosed in U.S. Pat. Nos. 8,647,781, 8,951,695, and 9,136,554 to Knuckey et al.

U.S. Pat. No. 9,209,476 to Knuckey et al. discloses the use of triarylamine redox mediators in conjunction with a redox catalyst.

Each of these previously disclosed redox mediator/redox catalyst systems exhibit significant disadvantages, such as high molecular weight of the redox mediators relative to the number of electrons they can transport, high cost, low stability of the redox mediator and/or redox catalyst, volatility of the redox mediator and/or redox catalyst, or the inability to tune the redox properties of the system.

In U.S. Pat. No. 9,711,818, which is incorporated by reference herein in its entirety, we disclosed a strategy specific for O₂ reduction at the cathode using specific classes of redox mediators in combination with redox catalysts that are not attached to the cathode, such as a metal complex dissolved in the catholyte (e.g, Co(salophen)). However, there is a continuing need for redox catalysts for use in such systems that can facilitate improved cathode half-cell performance.

Non-Pt transition metal macrocycles immobilized at the electrode have been extensively explored in the context of conventional fuel cells. The work in this field has recently been summarized by Liu et al. (Coord. Chem. Rev. 2016, 315, 153-177). The most notable such complexes include N4-donor ligands, such as phthalocyanines and porphyrins, using Co and Fe as the transition metal. These complexes can be immobilized onto carbon-based supports (e.g. carbon blacks, mesoporous carbon, carbon nanotubes) by non-destructive means (e.g. adsorption, impregnation), as well as by pyrolysis. Some of the most successful examples incorporating high activity and stability include catalysts synthesized by pyrolysis of Fe or Co salts and nitrogen-containing species on a carbon support (so-called M-N-C catalysts). Recent advances in this field have been covered by Nie et. al (Chem. Soc. Rev. 2015, 44, 2168-2201).

Typically, such complexes exhibit insufficient catalytic ORR activity for use in fuel cells. To offset ORR activity lower than that of Pt catalysts, increased amounts of the catalyst can be affixed to the electrode. However, the increase in electrode thickness leads to higher resistances at the electrode, lowering overall activity. Thus, it is not expected that such complexes would be useful as redox catalysts in high-power electrochemical cells for commercial applications.

### SUMMARY OF THE INVENTION

We disclose herein the use in flow-based cathodes of heterogenized non-Pt transition metal-containing catalysts synthesized from molecular precursors that are not in contact with the cathode electrode, in combination with redox mediators capable of transferring electrons and protons. By removing such redox catalysts (and the catalyzed oxygen reduction reaction) from the cathode electrode, we have effectively addressed the challenges associated with using such redox catalysts in electrochemical cells, such as insufficient catalytic activity.

In a first aspect, this disclosure encompasses a cathode half-cell that includes a cathode electrode and a heterogeneous redox catalyst that includes one or more non-Pt transition metals attached to a solid support. The cathode electrode and the heterogeneous redox catalyst are both in contact with an electrolyte solution. However, the heterogeneous redox catalyst is not in direct contact with the cathode electrode.

In some embodiments, the electrolyte solution is an aqueous solution. In some such embodiments, the electrolyte solution is acidic.

In some embodiments, the electrolyte solution includes a redox mediator that is capable of transferring or accepting electrons while undergoing reduction or oxidation. In some such embodiments, the redox mediator includes at least one carbon atom and is capable of transferring or accepting electrons and protons while undergoing reduction or oxidation. In some such embodiments, the redox mediator is water soluble.

In some embodiments, the redox mediator is dissolved in the electrolyte solution and is capable of moving freely within the electrolyte solution between the cathode electrode and the heterogeneous catalyst, and between the heterogeneous catalyst and the cathode electrode.

In some embodiments, the one or more non-Pt transition metals includes one or more first-row transition metals.

In some embodiments, the one or more non-Pt transition metals include cobalt (Co), manganese (Mn), iron (Fe), copper (Cu), vanadium (V), molybdenum (Mo), tungsten (W), nickel (Ni), and/or chromium (Cr).

In some embodiments, the solid support is at least partly made up of a carbon-based material, silica, a metal oxide, a chalcogenide, a nitride, an oxynitride, a carbide, or a boride.

In some embodiments, the heterogeneous redox catalyst includes a non-Pt transition metal-macrocycle complex or a non-Pt transition metal-pseudomacrocycle complex attached to the solid support. In some such embodiments, the non-Pt transition metal-macrocycle complex or non-Pt transition metal-pseudomacrocycle complex is deposited on, adsorbed to, or covalently linked to the solid support.

In some embodiments, the non-Pt transition metal-macrocyclic complex or non-Pt transition metal-pseudomacrocycle complex includes multidentate N-, O-, B-, C-, and/or S-donor ligands. In some such embodiments, the non-Pt transition metal-macrocycle complex is an N4 complex. In some such embodiments, the non-Pt transition metal-macrocycle complex is a phthalocyanine, a corrole, or a porphyrin.

In some embodiments, the heterogeneous redox catalyst includes a non-Pt transition metal attached to a nitrogen-doped carbon support (an M-N-C catalyst). In some such embodiments, the nitrogen-doped solid support includes one or more nitrogen-containing precursors deposited on the solid support alongside the one or more non-Pt transition metals. In some such embodiments, the nitrogen-containing precursors form a complex with the non-Pt transition metal.

In some embodiments, the one or more nitrogen-containing precursors are nitrogen-containing polymer precursors or nitrogen-containing ligands. In some embodiments, the one or more nitrogen-containing precursors may include ammonia, acetonitrile, pyrroles, imidazoles, phenanthrolines, and/or polyanilines.

In some embodiments, in making the heterogeneous redox catalyst, the solid support and the one or more non-Pt transition metals and nitrogen-containing precursors deposited thereon are heat treated, resulting in the non-Pt transition metal being attached to the solid support. In some such embodiments, the solid support that is heated also has a macrocycle or pseudomacrocycle deposited on it, and the macrocycle or pseudomacrocycle becomes attached to the solid support.

In some embodiments, the cathode half-cell further includes a reactor, that is separated from the cathode electrode, within which the heterogeneous redox catalyst is located. In some such embodiments, the cathode half-cell is configured to facilitate the flow of the electrolyte solution through the reactor. In some such embodiments, the cathode half-cell further includes a gas delivery inlet configured to facilitate the flow of O₂ through the reactor.

In some embodiments, the cathode half-cell further includes a gas delivery inlet configured to facilitate the flow of O₂ past the heterogeneous redox catalyst.

In some embodiments, the cathode half-cell further includes O₂. In some such embodiments, the O₂ is in contact with the heterogeneous redox catalyst. In some such embodiments, the cathode half-cell includes a redox mediator consisting of at least one carbon atom and capable of transferring or accepting electrons and protons while undergoing reduction or oxidation. The O₂ present in the cathode half-cell is actively being reduced to H₂O at the heterogeneous redox catalyst, and the reduced form of the redox mediator is actively being oxidized at the redox catalyst. In some such embodiments, the oxidized form of the redox mediator is actively being reduced at the cathode electrode, and the electrons being used to reduce the oxidized form of the redox mediator are being withdrawn from the cathode electrode. In some such embodiments, both O₂ and the redox mediator are flowing past the heterogeneous redox catalyst.

In some embodiments, the cathode half-cell includes a redox mediator consisting of at least one carbon atom and capable of transferring or accepting electrons and protons while undergoing reduction or oxidation, and the reduced form of the redox mediator is a substituted dihydroxybenzene or a substituted hydroxylamine. In some such embodiments, the substituted dihydroxybenzene is a substituted 1,2-dihydroxybenzene or a substituted 1,4-dihydroxybenzene.

In some embodiments where the reduced form of the redox mediator is a substituted dihydroxybenzene, in one or more of the hydrogen atom substitutions in the substituted dihydroxybenzene, the hydrogen atom is substituted with a substituent group that is independently an alkyl with less than ten carbons, an aryl, fused aryl, a heterocycle, an alkenyl, an alkynyl, a cycloalkyl, an amine, a protonated amine, a quaternary amine, sulfate, a sulfonate, a mercaptoalkylsulfonate, sulfonic acid, phosphate, a phosphonate, a phosphinate, a ketone, an aldehyde, an oxime, a hydrazine, a nitrone, an ether, an ester, a halide, a nitrile, a carboxylate, an amide, a thioether, a fluoroalkyl, a perfluoroalkyl, a pentafluorosulfanyl, a sulfonamide, a sulfonic ester, an imide, carbonate, a carbamate, a urea, a sulfonylurea, an azide, a sulfone, a sulfoxide, an amine oxide, phosphine oxide, a quaternary phosphonium, a quaternary borate, a siloxane, or a nitro and combinations of two or more thereof, and at least one of the substituents is charged to increase the aqueous solubility of the dihydroxybenzene. In some such embodiments, the fused aryl is naphthohydroquinone, anthrahydroquinone, or a derivative thereof.

In some embodiments where the reduced form of the redox mediator is a substituted hydroxylamine, in one or more of the nitrogen-bound hydrogen atom substitutions in the substituted hydroxylamine, the hydrogen atom is substituted with a substituent group that is independently an alkyl with less than ten carbons, an aryl, a cycloalkyl, or a bicycloalkyl, wherein both nitrogen-bound hydrogen atoms can be substituted with the same or different substituents, or wherein the two substituents may be linked, forming a heterocycle. In some such embodiments, one or more of the substituent groups further includes an alkyl with less than ten carbons, an aryl, a heterocycle, an alkenyl, an alkynyl, a cycloalkyl, an amine, a protonated amine, a quaternary amine, sulfate, a sulfonate, a mercaptoalkylsulfonate, sulfonic acid, phosphate, a phosphonate, a phosphinate, a ketone, an aldehyde, an oxime, a hydrazine, a nitrone, an ether, an ester, a halide, a nitrile, a carboxylate, an amide, a thioether, a fluoroalkyl, a perfluoroalkyl, a pentafluorosulfanyl, a sulfonamide, a sulfonic ester, an imide, carbonate, a carbamate, a urea, a sulfonylurea, an azide, a sulfone, a sulfoxide, an amine oxide, phosphine oxide, a quaternary phosphonium, a quaternary borate, a siloxane, a nitro, or combinations of two or more thereof on the same or on different positions on the substituent, and at least one of the substituents is charged to increase the aqueous solubility of the hydroxylamine.

In a second aspect, this disclosure encompasses an electrochemical cell that includes the cathode half-cell as described above, in combination with an anode half-cell that includes an anode electrode. In some embodiments, the anode half-cell is in at least partial ionic communication with the cathode half-cell.

In some embodiments, the anode electrode and the cathode electrode are connected through an electric circuit.

In some embodiments, the anode half-cell includes an anode inlet configured to supply the anode half-cell with a gaseous, liquid, or solid reactant. In some such embodiments, the electrochemical cell is a fuel cell, and the anode inlet is configured to supply the anode half-cell with a gaseous, liquid, or solid fuel.

In some embodiments, the electrochemical cell is an electrosynthetic cell, and the anode inlet is configured to supply the anode half-cell with a gaseous, liquid, or solid reactant that is capable of being oxidized to form a desired product.

In some embodiments, the anode half-cell and the cathode half-cell are separated by a semi-permeable membrane.

In some embodiments, the anode half-cell is a conventional anode half-cell, with the anode electrode being at least partly made of, being attached to, or otherwise in direct contact with an electrocatalyst capable of catalyzing the oxidation of the desired fuel or synthetic precursor. In some such embodiments, the anode half-cell is a conventional proton exchange membrane (PEM) fuel cell anode, with the electrocatalyst being capable of oxidizing a fuel.

In some embodiments, the anode half-cell includes an electrocatalyst capable of catalyzing anodic oxidation that is not in permanent direct contact with the anode electrode. In some such embodiments, the electrocatalyst is a heterogeneous electrocatalyst and the anode half-cell contains a mediator capable of transporting electrons from the electrocatalyst to the anode. In some such embodiments, the heterogeneous electrocatalyst comprises a solid support. In some embodiments, the electrocatalyst consists of a soluble species.

In a third aspect, this disclosure encompasses a method of producing a desired chemical product. The method includes the steps of contacting the electrocatalyst of the anode half-cell of the electrochemical cell as described above with a reductant that is a precursor of the desired chemical product, and contacting the cathode half-cell of the electrochemical cell with O₂. As a result of such contact, the precursor is oxidized to the desired product, and the O₂ is reduced.

In a fourth aspect, this disclosure encompasses a method of producing electricity. The method includes the steps of contacting the electrocatalyst of the anode half-cell of the electrochemical cell as described above with a fuel, and contacting the cathode half-cell of the electrochemical cell with O₂. As a result of such contact, the fuel is oxidized, the O₂ is reduced, and electricity is produced.

The following detailed description is of exemplary but non-limiting embodiments of our disclosure. The full scope of the disclosure is described in the appended claims.

### BRIEF DESCRIPTION OF THE DRAWINGS

FIG. 1A is a reaction scheme showing reaction conditions for the oxidation of 2,3,5,6-tetrakis(propylsulfanyl-2′-sulfonate)-1,4-hydroquinone tetrasodium salt (tetra(MPNSA) sodium salt hydroquinone) (reduced form) to its corresponding benzoquinone (oxidized form), 2,3,5,6-tetrakis(propylsulfanyl-2′-sulfonate)-1,4-benzoquinone tetrasodium salt, using as the catalyst platinum on carbon (Pt/C) or iron phthalocyanine on graphene oxide (Fe(Pc)/GO).

FIG. 1B is a graph of % yield over time for the reaction depicted in FIG. 1A, comparing the results obtained using the Pt/C and Fe(Pc)/GO catalysts and a control reaction with no catalyst. The graphed data was obtained using ¹H NMR spectroscopy. Using the Fe(Pc)/GO catalyst resulted in a much higher product yield over a shorter time course than the conventional Pt/C catalyst.

FIG. 2A is a reaction scheme showing reaction conditions for the oxidation of 2,3,5,6-tetrakis(propylsulfanyl-2′-sulfonate)-1,4-hydroquinone tetrasodium salt (tetra(MPNSA) sodium salt hydroquinone) (reduced form) to its corresponding benzoquinone (oxidized form), 2,3,5,6-tetrakis(propylsulfanyl-2′-sulfonate)-1,4-benzoquinone tetrasodium salt, using as the catalyst iron on nitrogen-doped carbon (Fe—N—C) or cobalt on nitrogen-doped carbon (Co—N—C).

FIG. 2B is a bar graph illustrating % yield obtained for the reaction depicted in FIG. 2A, comparing the results obtained using the Fe—N—C and Co—N-C catalysts and a control reaction with no catalyst. The graphed data was obtained using ¹H NMR spectroscopy.

FIG. 3 is a general scheme for flow-cathode based fuel cells with a “conventional” anode.

FIG. 4 is a voltage-current density plot for a fuel cell with a flow cathode using 0.1M tetra(MPNSA) sodium salt hydroquinone/benzoquinone as the redox mediator and H₂ as fuel with a conventional anode.

FIG. 5 is a single-pass time-on-stream experiment using a Co-phen/AC catalyst to aerobically oxidize an 0.1 M solution of tetra(MPSNA, sodium salt)hydroquinone. The conversion of the hydroquinone to the quinone was monitored by both ¹H NMR spectroscopy and an electrochemical assay.

FIG. 6 is a voltage-current density plot for a fuel cell using H₂ as a fuel and a flow cathode with an 0.1 M solution of tetra(MPSNA, sodium salt)hydroquinone as a redox mediator in 1 M H₂SO₄ and Co-phen/AC as the redox catalyst in a packed-bed reactor.

FIG. 7 is a constant voltage experiment for a fuel cell using H₂ as a fuel and a flow cathode with an 0.1 M solution of tetra(MPSNA, sodium salt)hydroquinone as a redox mediator in 1 M H₂SO₄ and Co-phen/AC as the redox catalyst in a packed-bed reactor.

FIG. 8 is a constant voltage experiment for a fuel cell with a flow cathode showing the performance when the reactor is shut off and back on.

FIG. 9 is a voltage-current density plot for a fuel cell using MeOH as a fuel and a flow cathode containing tetra(MPSNA, sodium salt)hydroquinone as a redox mediator and Co-phen/AC as the redox catalyst.

FIG. 10A is a reaction scheme showing reaction conditions for the oxidation of tetra(MPNSA, sodium salt)hydroquinone to its corresponding benzoquinone using different Co—N/C and Fe—N/C catalysts.

FIG. 10B is a bar graph illustrating % yield obtained for the reaction depicted in FIG. 10A, comparing the results obtained using different Fe—N—C and Co—N-C catalysts. The % yields were analyzed ¹H NMR spectroscopy.

FIG. 11 is a reaction scheme showing reaction conditions for the oxidation of bis(MPNSA, sodium salt),bis-CF₃, hydroquinone to its corresponding benzoquinone using a Co—N/C catalyst and a Pt/C catalyst.

### DETAILED DESCRIPTION OF EXEMPLARY EMBODIMENTS

### I. In General

This invention is not limited to the particular methodology, protocols, materials, and reagents described, as these may vary. Furthermore, the terminology used herein is for the purpose of describing particular embodiments only, and is not intended to limit the scope of the present invention which will be limited only by the pending claims.

As used herein and in the appended claims, the singular forms “a”, “an”, and “the” include plural reference unless the context clearly dictates otherwise. As well, the terms “a” (or “an”), “one or more” and “at least one” can be used interchangeably herein. The terms “comprising”, “including”, and “having” can be used interchangeably.

Unless defined otherwise, all technical and scientific terms used herein have the same meanings as commonly understood by one of ordinary skill in the art. Although any methods and materials similar or equivalent to those described herein can be used in the practice or testing of the present invention, the methods and materials of several embodiments are now described. All publications and patents specifically mentioned herein are incorporated by reference in their entirety for all purposes.

### II. The Invention

This disclosure encompasses a new type of cathode half-cell within an electrochemical cell (such as a fuel cell or electrosynthetic cell) that also includes an anode half-cell. The type of anode half-cell used is not limited, and the anode half-cell may use a variety of different oxidation chemistries. As non-limiting examples, liquid, gaseous, or solid fuels may be oxidized, and fuel oxidation at the anode may be mediated or unmediated.

The cathode half-cell is a flow cathode containing an aqueous solution with a dissolved redox mediator and a heterogeneous redox catalyst that is not in direct contact with the cathode electrode and is capable of reducing oxygen (O₂). The heterogeneous redox catalyst includes one or more non-Pt transition metals that are affixed to a solid support.

In operation, the oxidized form of the redox mediator is reduced at the cathode electrode, and the reduced form of the redox mediator then migrates to and is oxidized by contact with the redox catalyst, optionally within a flow reactor. Simultaneously with the oxidation of the reduced form of the redox mediator, O₂ is reduced by contact with the redox catalyst. The oxidized form of the redox mediator then migrates back to the cathode electrode, where the cycle repeats.

In some embodiments, the anode half-cell and cathode half-cell are separated by a permeable or semi-permeable membrane. In some embodiments, this membrane is a proton-exchange membrane.

In some embodiments, the reduced form of the redox mediator is a substituted dihydroxybenzene or a substituted hydroxylamine. In some embodiments, the substituted dihydroxybenzene is a 1,2- or a 1,4-dihydroxybenzene.

In embodiments where the reduced form of the redox mediator is a substituted dihydroxybenzene, one or more hydrogen atoms of the unsubstituted form of dihydroxybenzene is substituted with a substituent group. Exemplary substituent groups that could be independently substituted for each hydrogen atom include an alkyl with less than ten carbons, an aryl, fused aryl (e.g. naphthohydroquinone or anthrahydroquinone and derivatives thereof), a heterocycle, an alkenyl, an alkynyl, a cycloalkyl, an amine, a protonated amine, a quaternary amine, sulfate, a sulfonate, a mercaptoalkylsulfonate, sulfonic acid, phosphate, a phosphonate, a phosphinate, a ketone, an aldehyde, an oxime, a hydrazine, a nitrone, an ether, an ester, a halide, a nitrile, a carboxylate, an amide, a thioether, a fluoroalkyl, a perfluoroalkyl, a pentafluorosulfanyl, a sulfonamide, a sulfonic ester, an imide, carbonate, a carbamate, a urea, a sulfonylurea, an azide, a sulfone, a sulfoxide, an amine oxide, phosphine oxide, a quaternary phosphonium, a quaternary borate, a siloxane, or a nitro and combinations of two or more thereof, where at least one of the substituents is charged to increase the aqueous solubility of the dihydroxybenzene.

Exemplary redox mediators where the reduced form is a substituted dihydroxybenzene include, without limitation, 2,3,5,6-tetrakis(propylsulfanyl-2′-sulfonate)-1,4-hydroquinone (tetra(MPSNA)hydroquinone), 2,3,5,6-tetrakis(ethlysulfanyl-2′-sulfonate)-1,4-hydroquinone (tetra(MESNA) hydroquinone), or salts thereof. Other exemplary redox mediators are disclosed by U.S. Pat. No. 9,711,818, which is incorporated by reference herein in its entirety, and U.S. Patent Application Nos. 62/464,441; 62/518,032; and 62/567,292, which are also incorporated by reference herein in their entireties.

In embodiments where the reduced form of the redox mediator is a substituted hydroxylamine, one or more nitrogen-bound hydrogen atoms in an unsubstituted hydroxylamine is substituted with a substituent group. Exemplary substituent groups that could be independently substituted for each hydrogen include an alkyl with less than ten carbons, an aryl, a cycloalkyl, and a bicycloalkyl. In some embodiments, the same substituent group may substitute for two different hydrogen atoms, thus forming a heterocycle. In some embodiments, at least one form of the redox mediator may be a stable radical.

In some embodiments where the reduced form of the redox mediator is a substituted hydroxylamine, one or more of the substituent groups may further include an alkyl with less than ten carbons, an aryl, a heterocycle, an alkenyl, an alkynyl, a cycloalkyl, an amine, a protonated amine, a quaternary amine, sulfate, a sulfonate, a mercaptoalkylsulfonate, sulfonic acid, phosphate, a phosphonate, a phosphinate, a ketone, an aldehyde, an oxime, a hydrazine, a nitrone, an ether, an ester, a halide, a nitrile, a carboxylate, an amide, a thioether, a fluoroalkyl, a perfluoroalkyl, a pentafluorosulfanyl, a sulfonamide, a sulfonic ester, an imide, carbonate, a carbamate, a urea, a sulfonylurea, an azide, a sulfone, a sulfoxide, an amine oxide, phosphine oxide, a quaternary phosphonium, a quaternary borate, a siloxane, a nitro, or combinations of two or more thereof on the same or on different positions on the substituent, where at least one of the substituents is charged to increase the aqueous solubility of the substituted hydroxylamine.

In some embodiments, the redox catalyst contains one or more first-row transition metals that have been heterogenized through deposition, adsorption, covalent linking, or otherwise being attached to the support.

In some embodiments, the non-Pt transition metal is attached to macrocyclic or pseudomacrocyclic ligands.

In some embodiments, the support is a carbon-based material, silica, a metal oxide, a chalcogenide, a nitride, an oxynitride, a carbide, or a boride.

In some embodiments, the one or more non-Pt transition metals may be cobalt (Co), manganese (Mn), iron (Fe), copper (Cu), vanadium (V), molybdenum (Mo), tungsten (W), nickel (Ni), or chromium (Cr).

In some embodiments, the non-Pt transition metal-macrocyclic complex may consist of multidentate N-, O-, C-, B-, and/or S-donor ligands. In some such embodiments, the non-Pt transition metal macrocyclic complex may be an N4 complex. Non-limiting examples include a phthalocyanine, a corrole, or a porphyrin.

In some embodiments where the support is carbon, nitrogen-containing precursors are deposited on the support alongside the one or more non-Pt transition metals and the catalyst is heat treated, synthesizing a M-N-C catalyst.

In some embodiments, the heterogeneous redox catalyst is housed in a reactor through which both the redox mediator and O₂ flow in order to oxidize the reduced form of the redox mediator and to simultaneously reduce the O₂ to water.

Both the redox catalyst and the redox mediator can occur in oxidized, reduced, or intermediate forms (i.e., various “redox forms”). Accordingly, when a redox catalyst or redox mediator is identified in a particular form herein, such identification also includes the corresponding alternative redox forms, each of which would be readily apparent to one skilled in the art.

Because in the disclosed systems, the cathode electrode itself does not act as a catalyst, the type of cathode electrode used is not limited, and may comprise any electrode material that is typically used in the art. Examples include but are not limited to carbon paper or carbon cloth electrodes.

The following examples are offered for illustrative purposes only, and are not intended to limit the scope of the present invention in any way. Indeed, various modifications of the disclosed method in addition to those shown and described herein will become apparent to those skilled in the art from the foregoing description and the following examples and fall within the scope of the appended claims.

### Example 1—FePc/GO in Hydroquinone Oxidation

The graphene oxide (GO) support was synthesized from graphite powder by the process described in Hummers et al. J Am. Chem. Soc. 1958, 80, 1339. FePc/GO was synthesized from the graphene oxide prepared above and commercial Fe(Pc)Cl [iron(III)phthalocyanine chloride] according to the process in Liu et al. ACS Appl. Mater. Interfaces 2015, 7, 24063.

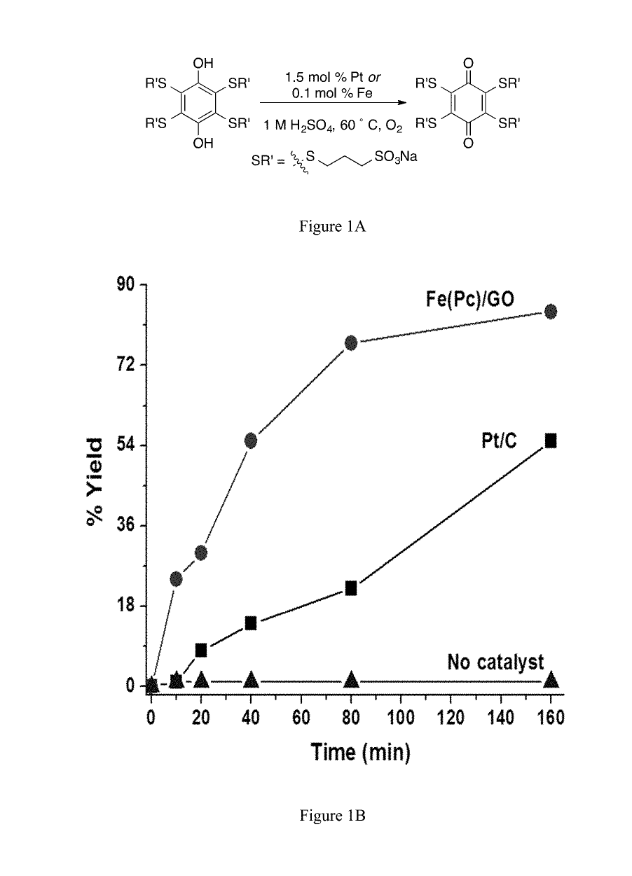

In a typical experiment to test for hydroquinone oxidation, either 2 wt % Fe(Pc)/GO (0.1 mol % Fe) or 10 wt % Pt/C (from Strem Chemicals, 1.5 mol % Pt) was added to a disposable 13 mm×100 mm thick-walled culture tube. The reaction tubes were then placed in a 48-well parallel reactor mounted on a Glas-Col large capacity mixer. The headspace was purged with O₂ for ca. 3 min, heated to 60° C. and 1.0 mL of 2,3,5,6-tetrakis(propylsulfanyl-2′-sulfonate)-1,4-hydroquinone tetrasodium salt (tetra(MPSNA, sodium salt) hydroquinone) solution (0.1M in 1M H₂SO₄) was injected into each vial. The reactions were shaken at 60° C. under 1 atm O₂ for the required time, after which mixing was stopped and the solutions filtered to remove the catalyst. FIG. 1A illustrates the reaction scheme used.

FIG. 1B depicts time courses for these catalysts, as determined by ¹H NMR. As shown in FIG. 1B, both the reaction yield and the reaction rate are substantially increased, as compared to using a conventional Pt on carbon redox catalyst. These data demonstrate that heterogenized non-Pt transition metal-macrocyclic complexes may be effectively used as redox catalysts, in combination with a soluble redox mediator (such as in flow cathodes for oxygen reduction).

### Example 2—M-N-C (Metal on Nitrogen-Doped Carbon) Catalysts in Hydroquinone Oxidation

Fe—N—C and Co—N-C catalysts were synthesized according to the process described in Beller et al. J. Am. Chem. Soc. 2013, 135, 10776. The metal sources were cobalt(II)acetate and iron(II)acetate, the nitrogen-containing ligand was 1,10-phenanthroline (phen), 1,10-phenanthroline-5,6-dione (phd), or 2,2′-bipyridine (bpy), and the carbon source was 20-40 mesh activated carbon. The metal and ligand were deposited in a 1:2 ratio on the support.

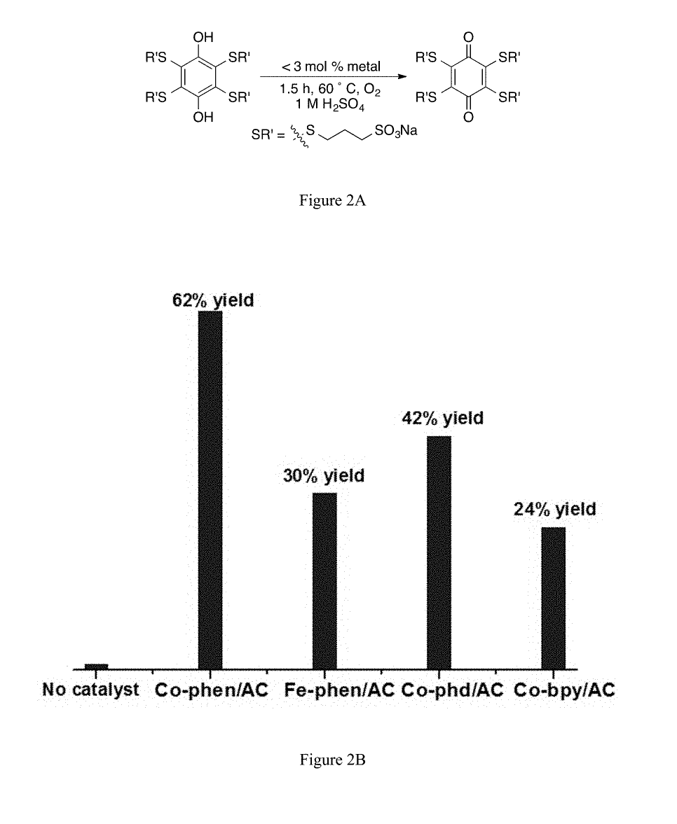

In a typical experiment for hydroquinone oxidation, either Fe—N-C (3 mol % Fe) or Co—N-C (2 mol % Co) was added to a disposable 13 mm×100 mm thick-walled culture tube. The reaction tubes were then placed in a 48-well parallel reactor mounted on a Glas-Col large capacity mixer. The headspace was purged with O₂ for ca. 3 min, heated to 60° C. and 1.0 mL of tetra(MPSNA, sodium salt)hydroquinone solution (0.1M in 1M H₂SO₄) was injected into each vial. The reactions were shaken at 60° C. under 1 atm O₂ for 1.5 h, after which mixing was stopped and the solutions filtered to remove the catalyst. FIG. 2A illustrates the reaction scheme used.

FIG. 2B shows the quinone yields by these catalysts, as determined by ¹H NMR spectroscopy. These data demonstrate that heterogenized non-Pt transition metal-nitrogen ligand complexes may be effectively used as redox catalysts, in combination with a soluble redox mediator (such as in flow cathodes for oxygen reduction).

### Example 3—Implementation of FePc/GO in Flow Cathode

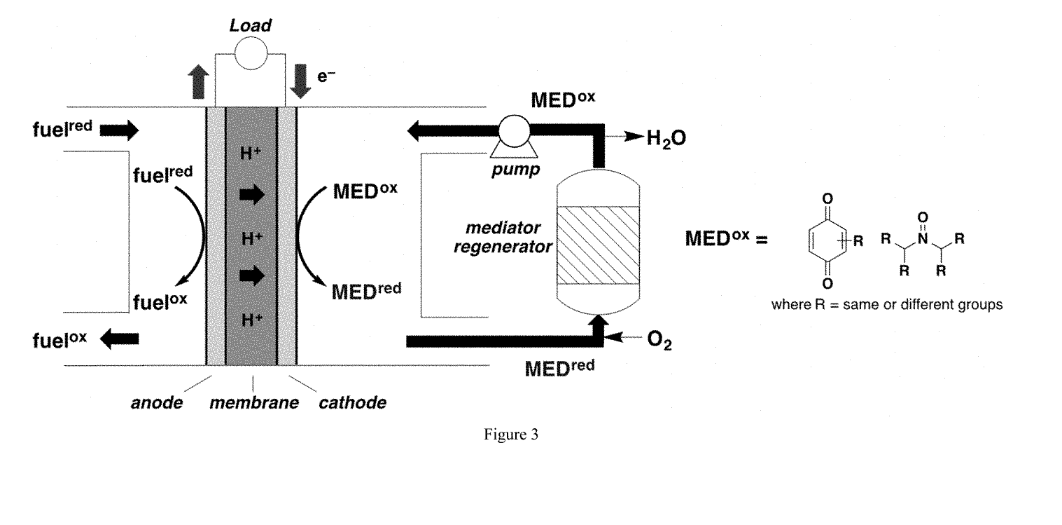

FIG. 3 depicts a general scheme for a regenerative redox cathode fuel cell with a conventional anode.

The mediator tetra(MPSNA, sodium salt)hydroquinone was implemented in a regenerative redox cathode with a conventional anode. We paired this mediator with a redox catalyst consisting of FePC/GO. A reservoir beaker was filled with 0.1 M of the tetra(MPSNA, sodium salt)hydroquinone in water, with 1 M H₂SO₄. A pump circulated the contents of the beaker through a reactor containing 0.475 g of FePc/GO. Oxygen was metered in co-current flow to the electrolyte. After reacting over the catalyst, the electrolyte was returned to the reservoir.

To monitor the extent of the hydroquinone oxidation, a working electrode (glassy carbon) and a reference electrode (Ag/AgCl) were placed into the reservoir. The measured potential was converted to a quinone:hydroquinone ratio using the Nernst equation.

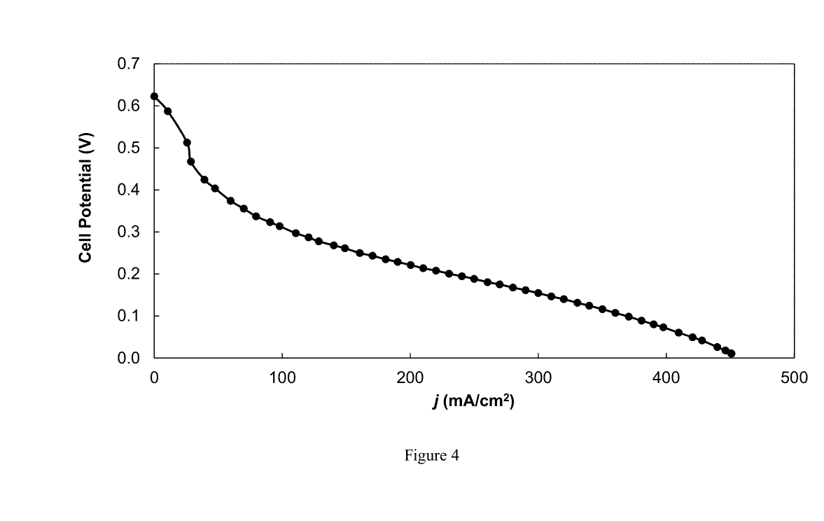

Once the reservoir contained at least 50% quinone (according to the measured potential), another pump was turned on and circulated the contents of the reservoir to the cathode side of a fuel cell. The fuel cell consisted of a membrane electrode assembly (MEA) of Nafion®117 (Dupont). On the anode side, a carbon fiber cloth containing 0.30 mg Pt/cm² was hot pressed onto the membrane. On the cathode side, carbon fiber cloth was laid against the membrane without hot pressing. Both sides had an electrode area of 5 cm² and used serpentine flow plates. The fuel cell was heated to 60° C. and H₂ was oxidized at the anode. In the cathode, the quinone was reduced to the hydroquinone and the electrolyte was circulated back to the reservoir. A voltage-current density plot was generated during simultaneous operation of the reactor and the fuel cell (FIG. 4).

As seen in FIG. 4, the data demonstrate the viability of a fuel cell containing a cathode half-cell using a heterogenized non-Pt transition-metal redox catalyst separated from the cathode electrode, in combination with a soluble redox mediator.

We interpret these results as a proof-of-concept that flow cathode half-cells including a soluble redox mediator paired with a heterogenized non-Pt transition metal redox catalyst separated from the cathode electrode can be utilized in improved electrochemical cells for the production of electricity (e.g., fuel cells) and/or synthesis of a desired product (e.g., electrosynthetic cells).

### Example 5—Time-On-Stream Experiment for Co-Phen/AC Catalyst

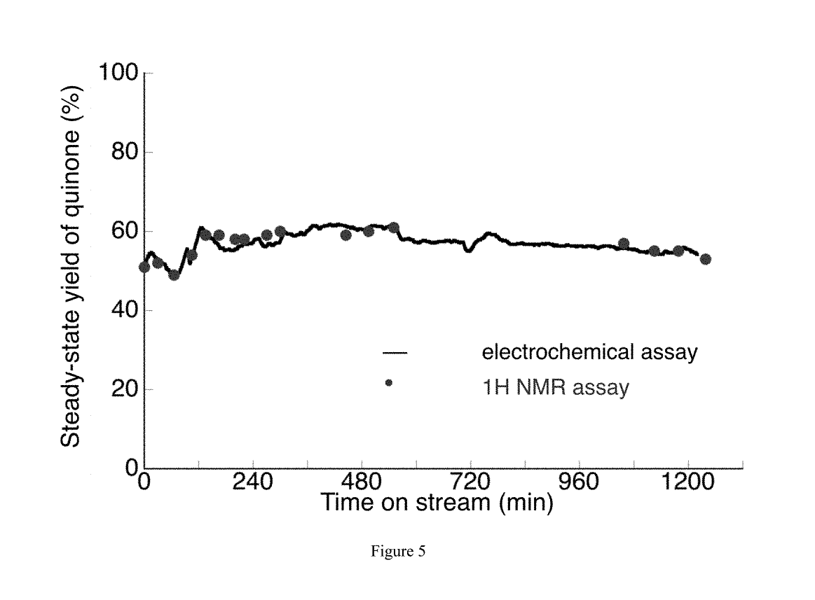

FIG. 5 shows the steady-state yield for the oxidation of tetra(MPSNA, sodium salt)hydroquinone by a Co-phen/AC catalyst, previously discussed in Example 2, in a continuous-flow packed-bed reactor.

A stainless steel tube, 0.25 in o.d.×3.5 in was packed with 1.5 in of glass wool inside a Swagelok fitting. On top of the glass wool, 0.25 g of Co-phen/AC was added, followed by more glass wool. A liquid solution (0.1 M tetra(MPSNA, sodium salt)hydroquinone in 1 M H₂SO₄) was pumped through the reactor at a flow rate of 0.25 mL/min using a Hitachi L-6200 HPLC pump. O₂ gas was flowed at a rate of 1.1 mL/min and controlled by a Teledyne Hastings mass flow meter. The liquid and gas feeds were mixed in an 0.125 in tee and sent through a pre-heating zone, after which they flowed into the packed-bed reactor in an upflow configuration. The pre-heating zone and packed-bed reactor were maintained at 50° C. by heating tape controlled by a built-in thermocouple. The conversion of hydroquinone to quinone was monitored by both ¹H NMR spectroscopy and a potentiometric sensor. The potentiometric sensor was constructed by fitting a bored-through Teflon block with an 0.25 in NPT fitting. A glassy carbon working electrode and Ag/AgCl reference electrode were inserted into the fluid path via two holes drilled into the Teflon block. A multimeter was used to measure the potential between the glassy carbon electrode and reference electrode, and this potential was converted to a hydroquinone:quinone ratio using the Nernst equation.

From the data presented in FIG. 5, it can be seen that the Co-phen/AC catalyst displays stable performance for over 20 hours. These results suggest that these M-N/C catalysts are sufficiently stable as hydroquinone oxidation catalysts.

### Example 6—Implementation of Co-Phen/AC Catalyst in a Flow Cathode with a Conventional H₂ Anode

A conventional H₂ anode was paired with a flow cathode consisting of 0.1 M tetra(MPSNA, sodium salt)quinone as the mediator in 1.0 M H₂SO₄ and Co-phen/AC in a packed-bed reactor as the redox catalyst. A 5 cm² membrane electrode assembly consisting of a Nafion117 membrane hot pressed with an anode of 0.5 mg Pt/cm² on carbon cloth was used. The cathode consisted of two pieces of Sigracell 29AA carbon paper treated with multi-walled carbon nanotubes. The flow plates used interdigitated flow paths and consisted of resin-filled graphite plates. During operation, the cell was heated to 60° C. by the fuel cell test station, and the H₂ flow was set to 0.2 L/min without humidification.

A reservoir was placed between the cathode and the mediator regenerator reactor to enable dissimilar flow rates in the fuel cell and mediator regenerator. A Cole-Palmer peristaltic pump circulated the contents of the reservoir through a 6.25 in long×0.5 in outer diameter stainless steel packed-bed reactor set to 50° C. and containing 5 g Co-phen/AC catalyst.

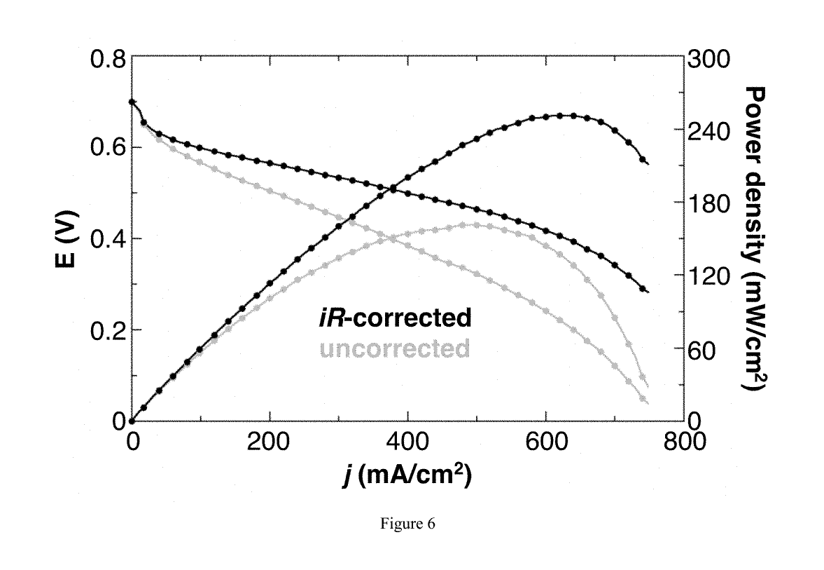

FIG. 6 shows a polarization curve collected using the assembly described above. The mediator solution was flowed through the packed-bed reactor at a flow rate of 15 mL/min with an O₂ flow rate of 10 mL/min. Once the quinone:hydroquinone ratio reached approximately 95:5, H₂ was flowed through the anode at 0.2 L/min and the mediator solution was flowed through the cathode at 100 mL/min. Both iR-corrected and iR-uncorrected data are shown in FIG. 6.

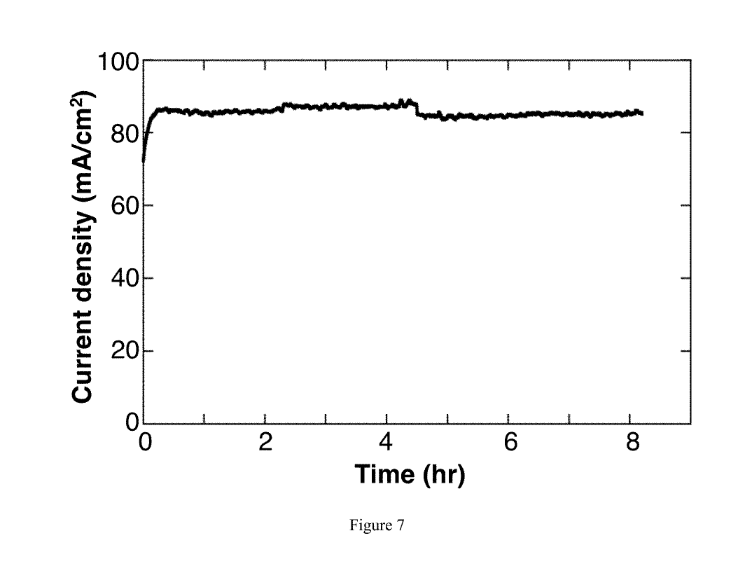

This same assembly was used to examine the long-term performance of this fuel cell system. The fuel cell was set to a potential of 0.5 V, and the current density was monitored for 8 hours. The results from this experiment are shown in FIG. 7. For this experiment, the H₂ flow rate through the anode was 0.2 L/min, the liquid flow rate through the cathode was 50 mL/min, the liquid flow rate through the reactor was 15 mL/min, and the O₂ flow rate was 10 mL/min. This system achieved approximately 90 mA/cm² performance for the 8 hour run.

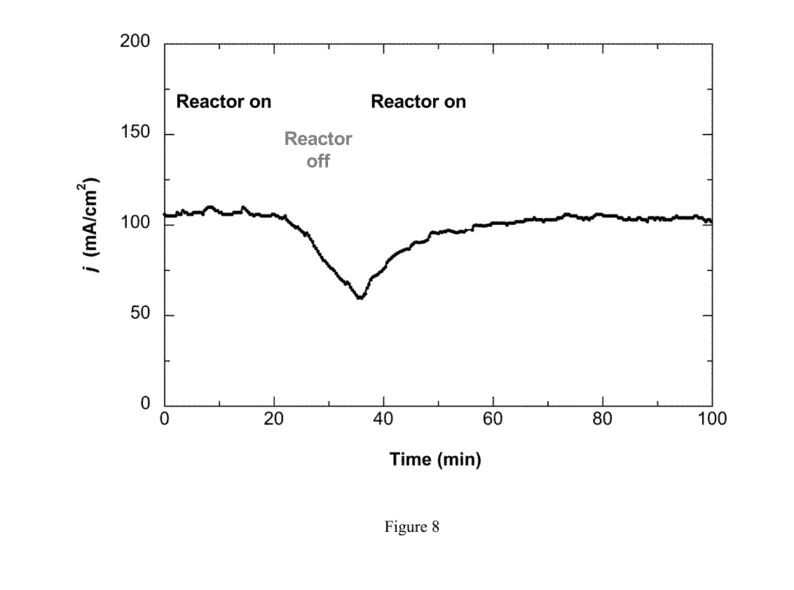

To assess the role that mediator regeneration plays in the flow cathode system, in a separate experiment using similar parameters as those discussed above (mediator flow rate through the reactor was 29 mL/min, O₂ flow rate of 10 mL/min), the O₂ flow in the reactor was stopped, while fuel cell operation continued. Once the O₂ flow was stopped, the current density began dropping from a steady-state of approximately 110 mA/cm² due to the decrease in quinone:hydroquinone ratio. After approximately 16 minutes, O₂ flow was resumed, and the current density of the fuel cell began to increase, eventually reaching >100 mA/cm². These data are presented in FIG. 8.

We interpret the results from these experiments as further proof that the pairing of a heterogeneous non-Pt catalyst with a soluble, carbon-containing redox mediator can lead to effective O₂ reduction in a flow cathode.

### Example 7—Implementation of Co-Phen/AC Catalyst in a Flow Cathode with a Conventional MeOH Anode

A conventional MeOH anode was paired with a flow cathode consisting of an 0.75 M solution of tetra(MPSNA, acid form)quinone in 1 M H₂SO₄ and Co-phen/AC as the redox catalyst. A 5 cm² membrane electrode assembly consisting of a Nafion117 membrane hot pressed with an anode containing 4 mg/cm² of a Pt/Ru catalyst on carbon cloth was used. The cathode consisted of two pieces of Sigracell 29AA carbon paper treated with multi-walled carbon nanotubes. Graphite plates were used as flow plates, with an interdigitated flow path on the cathode side and a serpentine flow path on the anode side. During operation, the cell was heated to 60° C. by the fuel cell test station.

A reservoir was placed between the cathode and the mediator regenerator reactor to enable dissimilar flow rates in the fuel cell and mediator regenerator. A Cole-Palmer peristaltic pump circulated the contents of the reservoir through a 6.25 in long×0.5 in outer diameter stainless steel packed-bed reactor set to 50° C. and containing 5 g Co-phen/AC catalyst.

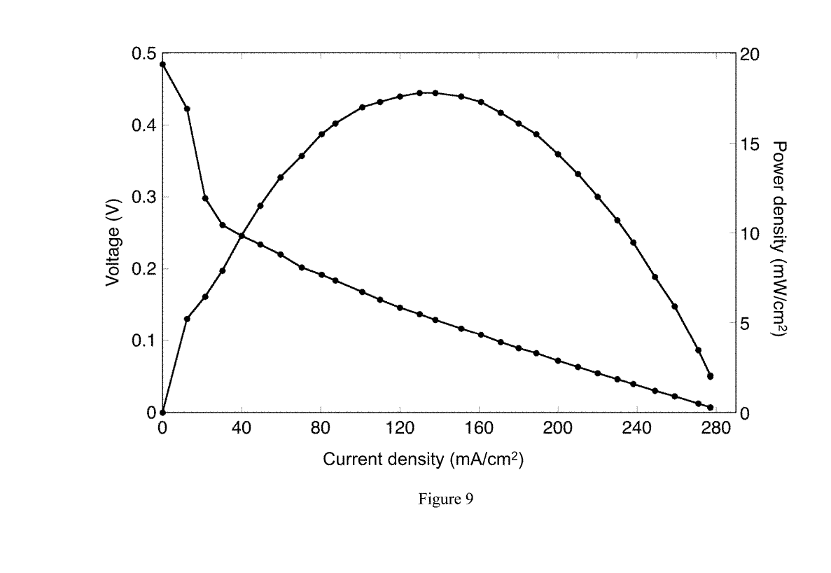

FIG. 9 shows a polarization curve collected using the assembly described above. The mediator solution was flowed through the packed-bed reactor at a flow rate of 15 mL/min with an O₂ flow rate of 10 mL/min. The cathode solution flowed through the fuel cell at 30 mL/min. The anode solution contained 1 M MeOH, and flowed through the fuel cell at 5 mL/min.

We interpret these results as a proof-of-concept that flow cathode half-cells including a soluble redox mediator paired with a heterogenized non-Pt transition metal redox catalyst separated from the cathode electrode can be utilized in improved electrochemical cells for the production of electricity (e.g., fuel cells) with a liquid-based fuel, such as methanol.

### Example 8—Hydroquinone Oxidation by Powdered M-N/C Catalysts

M-N/C catalysts on powdered supports were also examined for their activity in aerobic oxidation of hydroquinones. Catalysts using 1,10-phenanthroline (phen) as a nitrogen source (Co-Phen-C) were synthesized analogously to those presented in Example 2 using a powdered carbon source as the support. Co-DCD-C was prepared following the procedure outlined in Wang et al. ACS. Catal. 2014, 4, 3928-3936. Co-CM-C was prepared by adapting the procedure presented in Chung et. al. Electrochem. Commun. 2010, 12, 1792-1795. Co-PANI-C and Fe-PANI-C were prepared by adapting the procedure found in Wu et al. Science, 2011, 332, 443-447. Co-(PANI+CM)-C was prepared by adapting the procedure from Chung et al. Science, 2017, 357, 479-484.

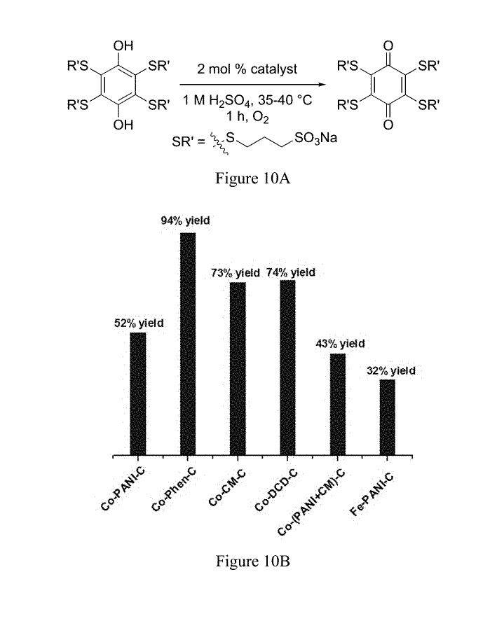

In a typical experiment for hydroquinone oxidation, (2 mol % M-N/C catalyst, as determined by ICP) was added to a disposable 13 mm×100 mm thick-walled culture tube. An 0.5 mL solution of 1 M H₂SO₄ was added to each tube, and the mixture was sonicated for 30 minutes. The reaction tubes were then placed in a 48-well parallel reactor mounted on a Glas-Col large capacity mixer. The headspace was purged with O₂ for ca. 3 min, heated to 35° C. (in the case of Co) or 40° C. (in the case of Fe) and 0.5 mL of tetra(MPSNA, sodium salt)hydroquinone solution (0.2M in 1M H₂SO₄) was injected into each vial. The reactions were shaken at 35 or 40° C. under 1 atm O₂ for 1 h, after which mixing was stopped and the solutions filtered to remove the catalyst. FIG. 10A illustrates the reaction scheme used.

FIG. 10B shows the quinone yields by these catalysts, as determined by ¹H NMR spectroscopy. These data demonstrate that heterogenized non-Pt transition metal-nitrogen ligand complexes may be effectively used as redox catalysts, in combination with a soluble redox mediator (such as in flow cathodes for oxygen reduction).

### Example 9—Oxidation of Higher Potential Hydroquinone

In order to show that quinones other than tetra(MPSNA, sodium salt)hydroquinone are capable of acting as mediators in this system, the aerobic oxidation of bis(MPSNA, sodium salt)-bis(CF₃)-hydroquinone with a Pt/C catalyst and an Co—N/C catalyst was examined. This quinone has a redox potential approximately 100 mV higher than the redox potential of tetra(MPSNA, sodium salt)benzoquinone.

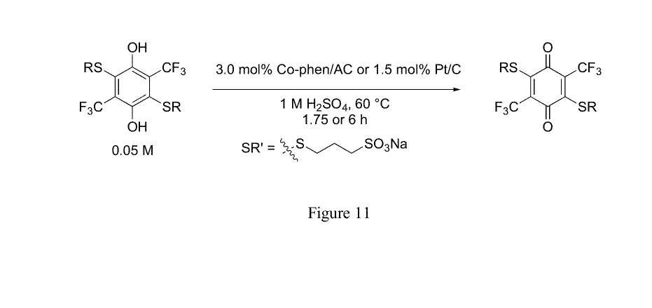

In these experiments for hydroquinone oxidation, either 1.5 mol % Pt/C (10 wt %, Strem) or 3 mol % Co-Phen-AC (as synthesized) was added to a disposable 13 mm×100 mm thick-walled culture tube. The reaction tubes were then placed in a 48-well parallel reactor mounted on a Glas-Col large capacity mixer. The headspace was purged with O₂ for ca. 3 min, heated to 60° C. and 0.5 mL of bis(CF₃)-bis(MPSNA, sodium salt)-hydroquinone solution (0.05M in 1M H₂SO₄) was injected into the vial. The reactions were shaken at 60° C. under 1 atm O₂ for 6 h (for Pt/C catalyst) or 1.5 h (for Co-Phen/AC catalyst), after which mixing was stopped and the solutions filtered to remove the catalyst. FIG. 11 illustrates the reaction scheme used.

The yield, as determined by ¹H NMR spectroscopy, for the experiment using the Pt/C catalyst was 5.3% and for the experiment using the Co-phen/AC catalyst was 43%. These data demonstrate that heterogenized non-Pt transition metal-nitrogen ligand complexes may be effectively used as redox catalysts, in combination with a higher potential, soluble redox mediator (such as in flow cathodes for oxygen reduction).

While a number of embodiments of the present invention have been described above, the present invention is not limited to just these disclosed examples. There are other modifications that are meant to be within the scope of the invention and claims. Thus, the claims should be looked to in order to judge the full scope of the invention.

1. A cathode half-cell comprising:
a heterogeneous redox catalyst comprising one or more non-Pt transition metals attached to a solid support, and
a cathode electrode;
wherein the cathode electrode and the heterogeneous redox catalyst are both in contact with an electrolyte solution, and wherein the heterogeneous redox catalyst is not in direct contact with the cathode electrode; and
wherein the electrolyte solution contains a soluble redox mediator capable of transporting electrons between the cathode electrode and the redox catalyst.

2. (canceled)

3. The cathode half-cell of claim 2, wherein the electrolyte solution is acidic.

4. The cathode half-cell of claim 1, wherein the electrolyte solution comprises a redox mediator comprising at least one carbon atom and that is capable of transferring or accepting electrons and protons while undergoing reduction or oxidation.

5. The cathode half-cell of claim 1, wherein the one or more non-Pt transition metals include one or more first-row transition metals.

6. The cathode half-cell of claim 1, wherein the one or more non-Pt transition metals are selected from the group consisting of cobalt (Co), manganese (Mn), iron (Fe), copper (Cu), vanadium (V), molybdenum (Mo), tungsten (W), nickel (Ni), and chromium (Cr).

7. The cathode half-cell of claim 1, wherein the solid support comprises a carbon-based material, silica, a metal oxide, a chalcogenide, a nitride, an oxynitride, a carbide, or a boride.

8. The cathode half-cell of claim 1, wherein the heterogeneous redox catalyst comprises a non-Pt transition metal-macrocycle complex or a non-Pt transition metal-pseudomacrocycle complex attached to the solid support.

9. (canceled)

10. The cathode half-cell of claim 8, wherein the non-Pt transition metal-macrocyclic complex or non-Pt transition metal-pseudomacrocycle complex comprises multidentate N-, O-, B-, C-, and/or S-donor ligands.

11. The cathode half-cell of claim 10, wherein the non-Pt transition metal-macrocycle complex is an N4 complex.

12. (canceled)

13. The cathode half-cell of claim 1, wherein the heterogeneous redox catalyst comprises one or more non-Pt transition metals on a nitrogen-doped carbon support (an M-N-C catalyst).

14. The cathode half-cell of claim 13, wherein the nitrogen-doped solid support comprises one or more nitrogen-containing precursors deposited on the solid support alongside the one or more non-Pt transition metals.

15.-19. (canceled)

20. The cathode half-cell of claim 1, further comprising a reactor that is separated from the cathode electrode within which the heterogeneous redox catalyst is located.

21.-28. (canceled)

29. The cathode half-cell of claim 1, wherein the cathode half-cell comprises a redox mediator comprising at least one carbon atom and is capable of transferring or accepting electrons and protons while undergoing reduction or oxidation, and wherein the reduced form of the redox mediator is selected from the group consisting of a substituted dihydroxybenzene and a substituted hydroxylamine.

30. The cathode half-cell of claim 29, wherein the substituted dihydroxybenzene is a substituted 1,2-dihydroxybenzene or a substituted 1,4-dihydroxybenzene.

31. The cathode half-cell system of claim 29, wherein in one or more of the hydrogen atom substitutions in the substituted dihydroxybenzene, the hydrogen atom is substituted with a substituent group that is independently selected from the group consisting of an alkyl with less than ten carbons, an aryl, fused aryl, a heterocycle, an alkenyl, an alkynyl, a cycloalkyl, an amine, a protonated amine, a quaternary amine, sulfate, a sulfonate, a mercaptoalkylsulfonate, sulfonic acid, phosphate, a phosphonate, a phosphinate, a ketone, an aldehyde, an oxime, a hydrazine, a nitrone, an ether, an ester, a halide, a nitrile, a carboxylate, an amide, a thioether, a fluoroalkyl, a perfluoroalkyl, a pentafluorosulfanyl, a sulfonamide, a sulfonic ester, an imide, carbonate, a carbamate, a urea, a sulfonylurea, an azide, a sulfone, a sulfoxide, an amine oxide, phosphine oxide, a quaternary phosphonium, a quaternary borate, a siloxane, or a nitro and combinations of two or more thereof, wherein at least one of the substituents is charged to increase the aqueous solubility of the dihydroxybenzene.

32. (canceled)

33. The cathode half-cell of claim 29, wherein in one or more of the nitrogen-bound hydrogen atom substitutions in the substituted hydroxylamine, the hydrogen atom is substituted with a substituent group that is independently selected from the group consisting of an alkyl with less than ten carbons, an aryl, a cycloalkyl, and a bicycloalkyl, wherein both nitrogen-bound hydrogen atoms can be substituted with the same or different substituents, and wherein the two substituents may be linked, forming a heterocycle.

34. The cathode half-cell of claim 33, wherein one or more of the substituent groups further comprises an alkyl with less than ten carbons, an aryl, a heterocycle, an alkenyl, an alkynyl, a cycloalkyl, an amine, a protonated amine, a quaternary amine, sulfate, a sulfonate, a mercaptoalkylsulfonate, sulfonic acid, phosphate, a phosphonate, a phosphinate, a ketone, an aldehyde, an oxime, a hydrazine, a nitrone, an ether, an ester, a halide, a nitrile, a carboxylate, an amide, a thioether, a fluoroalkyl, a perfluoroalkyl, a pentafluorosulfanyl, a sulfonamide, a sulfonic ester, an imide, carbonate, a carbamate, a urea, a sulfonylurea, an azide, a sulfone, a sulfoxide, an amine oxide, phosphine oxide, a quaternary phosphonium, a quaternary borate, a siloxane, a nitro, or combinations of two or more thereof on the same or on different positions on the substituent, and wherein at least one of the substituents is charged to increase the aqueous solubility of the hydroxylamine.

35. An electrochemical cell comprising the cathode half-cell of claim 1 and an anode half-cell comprising an anode electrode.

36.-47. (canceled)

48. A method of producing a desired chemical product, comprising contacting the electrocatalyst of the anode half-cell of the electrochemical cell of claim 35 with a reductant that is a precursor of the desired chemical product, and contacting the cathode half-cell of the electrochemical cell of any of claim 35 with O₂, whereby the precursor is oxidized to the desired product, and O₂ is reduced.

49. A method of producing electricity, comprising contacting the electrocatalyst of the anode half-cell of the electrochemical cell of claim 35 with a fuel, and contacting the cathode half-cell of the electrochemical cell of claim 35 with O₂, whereby the fuel is oxidized, the O₂ is reduced, and electricity is produced.
